(19) United States
(12) Patent Application Publication
(10) Pub. No.: US 2018/0265142 A1
(43) Pub. Date: Sep. 20, 2018

(54) ACTIVE AERODYNAMIC UNDERBODY SHIELD SYSTEM AND METHOD OF LIFT BALANCE ADJUSTMENT

(71) Applicant: FORD GLOBAL TECHNOLOGIES, LLC, Dearborn, MI (US)

(72) Inventors: Matthew Arthur Titus, Livonia, MI (US); Michael Stephen Sylvester, Berkley, MI (US); Jack Wiley Cooper, Novi, MI (US)

(21) Appl. No.: 15/462,310

(22) Filed: Mar. 17, 2017

(51) Int. Cl. B62D 37/02; B62D 35/02; B62D 15/02; B60T 17/22; B60T 7/04; G01M 17/007; G01P 3/00; G01P 15/00; G01K 1/14

(52) U.S. Cl. CPC B62D 37/02; B62D 35/02; B62D 15/021; B60T 17/22; G01K 1/14; G01M 17/007; G01P 3/00; G01P 15/00; B60T 7/04

(57) ABSTRACT

An active aerodynamic underbody shield system includes an underbody shield with a vent, a panel displaceable between a vent closing position and a vent opening position, an actuator to displace the panel and a controller for the actuator. The controller is configured to open the vent during vehicle braking to reduce downforce and therefore provide better lift balance adjustment for the motor vehicle. A method of reducing downforce and providing better lift balance adjustment during vehicle braking is also provided.

### TECHNICAL FIELD

This document relates generally to the motor vehicle equipment field and, more particularly, to an active aerodynamic underbody shield system as well as to a related method of providing better lift balance adjustment of a motor vehicle during motor vehicle braking.

### BACKGROUND

Automotive underbody shields have been utilized for aerodynamic benefit, thermal protection and component/vehicle protection. A passive underbody device cannot be designed to fully satisfy these different attributes and compromises in overall performance result.

More specifically, underbody shields may generate downforce via reducing pressure to lower than ambient. The magnitude of pressure reduction increases as the shield moves closer to the ground plane and/or pitching attitude increases. There can be large downforce changes as the vehicle's height and attitude change compared to the ground plane which can noticeably affect handling and braking performance. In addition, underbody shields are drag reduction components that can also reduce airflow for cooling. Passive underbody shields can create a compromise between drag and cooling performance. However, not all operating states in a vehicle require the maximum amount of cooling. Significantly, an active underbody shield could better align vehicle cooling performance with vehicle cooling demand for varying operating states.

This document relates to an active aerodynamic underbody shield system having a vent that may be opened or closed as required to best meet the needs of the operating state of the motor vehicle. When the vehicle is operating at a steady state, the vent is closed to minimize drag and provide maximum fuel economy. If the vehicle is in a thermal taxing environment, the vent may be opened to provide additional mass airflow for enhanced cooling. In addition, the vent may be utilized to adjust the vehicle aerodynamic lift balance or pitch sensitivity. Toward this end the vent may be maintained in a closed position for all vehicle attitudes or operating states except braking. Under braking, the vent may be opened to reduce the effectiveness for generating downforce (suction) to a level which is similar to the straightaway vehicle attitude. This improves driver confidence and can be a substantial performance benefit.

### SUMMARY

In accordance with the purposes and benefits described herein, an active aerodynamic underbody shield system is provided. That active aerodynamic underbody shield system comprises an underbody shield including a vent, a panel displaceable between a vent closing position and a vent opening position, an actuator to displace the panel and a controller for the actuator. The controller is configured to open the vent during vehicle braking to reduce downforce and thereby provide better lift balance adjustment for the motor vehicle incorporating the active aerodynamic underbody shield system.

The underbody shield system may further include a panel support having a guideway. That guideway may include opposed guide channels. The panel may slide in those opposed guide channels between the vent closing position and the vent opening position.

The actuator may be connected to the panel by means of a linkage. The actuator may be selected from a group consisting of an engine vacuum actuator, an electrical actuator, a solenoid, a pneumatic actuator and the hydraulic actuator. In one possible embodiment, the linkage may comprise a first link and a second link. The first link is connected by a pivot pin to the underbody shield. The first link has a first end connected to the actuator and a second end connected to the second link. The second link may be connected to the panel.

The underbody shield system may further include a mesh cover across the vent to prevent ingestion of gravel, sticks and other road debris.

The controller may be configured to include at least one data input. Further, the active aerodynamic underbody shield system may further include at least one monitoring device connected to the at least one data input. The at least one monitoring device may be selected from a group consisting of a brake pedal actuation switch, a brake pressure monitor, a vehicle speed monitor, a lateral acceleration monitor, a longitudinal acceleration monitor, a ride height monitor, a front wheel position monitor, a steering wheel angle monitor and combinations thereof.

In some embodiments the active aerodynamic underbody shield system may further include an additional monitoring device connected to an additional data input. That additional monitoring device may be selected from a second group consisting of an engine coolant temperature monitor, an engine cylinder temperature monitor and combinations thereof.

In accordance with an additional aspect, a method is provided of reducing downforce and providing better lift balance adjustment during vehicle braking. That method comprises the steps of: (a) detecting, by a monitoring device, vehicle braking, (b) opening, by an actuator, a vent in an underbody shield and (c) controlling the actuator by a controller configured to open the vent during vehicle braking.

The method may further include the step of monitoring brake pedal activation with the monitoring device. The method may also include the step of monitoring brake pressure with the monitoring device. The method may also include monitoring vehicle speed with the monitoring device. The method may include monitoring vehicle lateral acceleration with the monitoring device. The method may include monitoring vehicle longitudinal acceleration with the monitoring device. The method may include monitoring vehicle ride height with the monitoring device. The method may include monitoring a front wheel position with the monitoring device. The method may also include monitoring steering wheel angle with the monitoring device.

Still further, the method may include monitoring motor operating temperature.

In the following description, there are shown and described several preferred embodiments of the active aerodynamic underbody shield system as well as the related method of reducing downforce and providing better lift balance adjustment during vehicle braking. As it should be realized, the active aerodynamic underbody shield system and method are capable of other, different embodiments and their several details are capable of modification in various, obvious aspects all without departing from the active aerodynamic underbody shield system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the active aerodynamic underbody shield system and related method and together with the description serve to explain certain principles thereof. In the drawing figures:

FIG. 1 is a schematic block diagram of the active aerodynamic underbody shield system.

FIG. 2a is a top plan view illustrating the displaceable panel of the active aerodynamic underbody shield system in the vent closing position.

FIG. 2b is a cross sectional view along line 2b-2b of FIG. 2a.

FIG. 3 is a top plan view similar to FIG. 2a but illustrating the displaceable panel of the active aerodynamic underbody shield system in the vent opening position.

FIG. 4 is a control logic flow diagram for one possible embodiment of the active aerodynamic underbody shield system.

Reference will now be made in detail to the present preferred embodiments of the active aerodynamic underbody shield system, examples of which are illustrated in the accompanying drawing figures.

### DETAILED DESCRIPTION

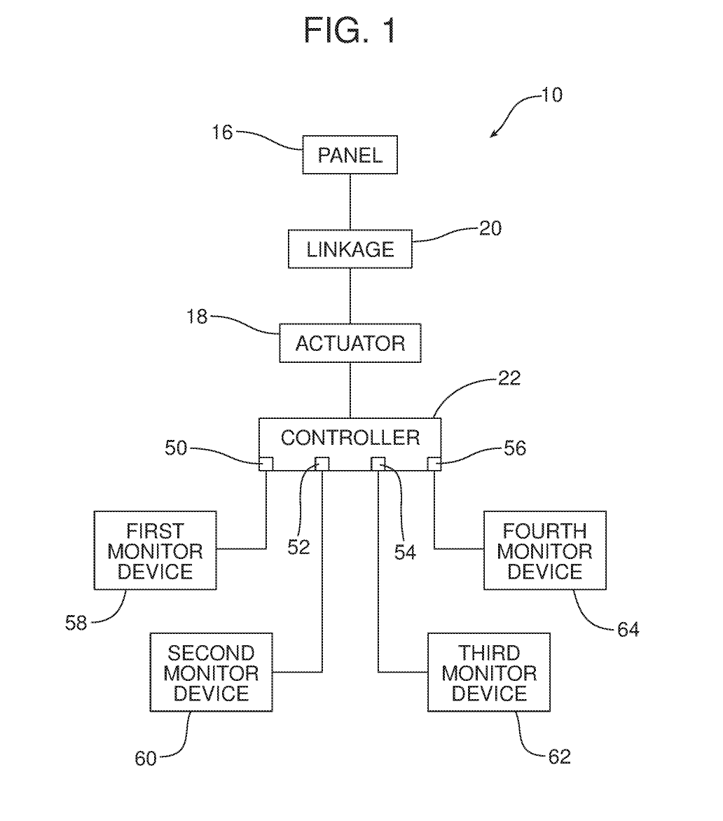

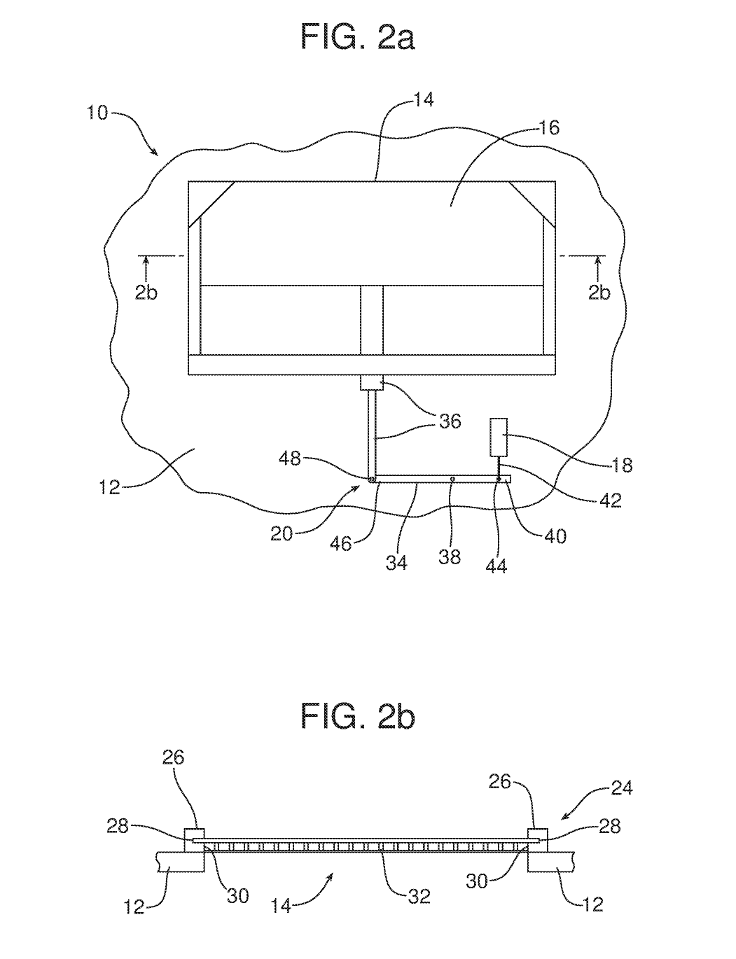

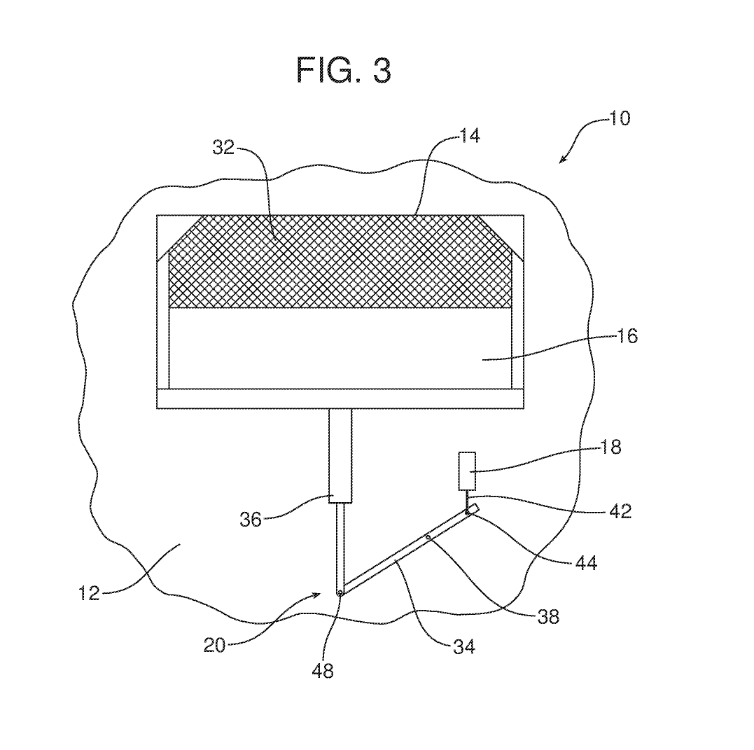

Reference is now made to FIGS. 1, 2a, 2b and 3 illustrating one possible embodiment of the active aerodynamic underbody shield system 10. That active aerodynamic underbody shield system 10 includes an underbody shield 12 including a vent 14. The active aerodynamic underbody shield system 10 also includes a panel 16 displaceable between a vent closing position, illustrated in FIGS. 2a and 2b, and a vent opening position illustrated in FIG. 3. An actuator 18 displaces the panel 16 between the vent closing and vent opening positions. A linkage 20 connects the actuator 18 with the panel 16. A controller 22 is provided to control the actuator 18.

In the illustrated embodiment the controller 22 comprises a computing device such as a dedicated microprocessor or an electronic control unit (ECU) operating in accordance with instructions from appropriate control software. Thus, the controller 22 may comprise one or more processors, one or more memories and one or more network interfaces all in communication with each other over a communication bus.

The controller 22 is configured to open the vent 14 during vehicle braking in order to reduce downforce and thereby provide better lift balance adjustment to the motor vehicle. Advantageously, this provides enhanced motor vehicle stability which improves driver confidence and results in a significant performance benefit.

More specifically, the active aerodynamic underbody shield system 10 includes a panel support 24 including a guideway 26. In the illustrated embodiment, the guideway 26 includes opposed guide channels 28 outboard the lateral ends 30 of the vent 14. The panel 16 slides in the guide channels 28 as the panel is displaced between the vent closing position illustrated in FIGS. 2a and 2b and the vent opening position illustrated in FIG. 3.

The active aerodynamic underbody shield system 10 may also include a mesh cover 32 extending across the vent 14. The mesh cover 32 allows relatively free passage of air through the vent 14 when the panel 16 is in the vent opening position but prevents the ingestion of gravel, sticks and other roadway debris.

The actuator 18 may assume substantially any form appropriate for the purpose of displacing the panel 16 between the vent closing and vent opening positions. Thus, it should be appreciated that the actuator 18 may comprise an engine vacuum actuator, an electrical actuator, a solenoid, a pneumatic actuator and a hydraulic actuator.

In the illustrated embodiment, the linkage 20 comprises a first link 34 and a second link 36. The first link 34 is connected by means of a pivot pin 38 to the underbody shield. The first end 40 of the first link 34 is connected to the arm 42 of the actuator 18 by means of the pin 44. The second end 46 of the first link 34 is connected to the second link 36 by means of the pin 48. The opposite end of the second link 36 is connected to the panel 16. As should be appreciated the specific linkage 20 illustrated in drawing FIGS. 2a and 3 is merely presented for purposes of illustration and should not be considered as limiting in scope.

As best illustrated in FIG. 1, the controller 22 is configured to include at least one data input. In the illustrated embodiment, the controller 22 includes a first data input 50, a second data input 52, a third data input 54 and a fourth data input 56. The first data input 50 is connected to a first monitoring device 58, the second data input 52 is connected to a second monitoring device 60, the third data input 54 is connected to a third monitoring device 62 and the fourth data input 56 is connected to a fourth monitoring device 64.

The first monitoring device 58, the second monitoring device 60, the third monitoring device 62 and the fourth monitoring device 64 may be selected from a first group consisting of a brake pedal actuation switch, a brake pressure monitor, a vehicle speed monitor, a vehicle lateral acceleration monitor, a vehicle longitudinal acceleration monitor, a ride height monitor, a front wheel position monitor, a steering wheel angle monitor, and combinations thereof.

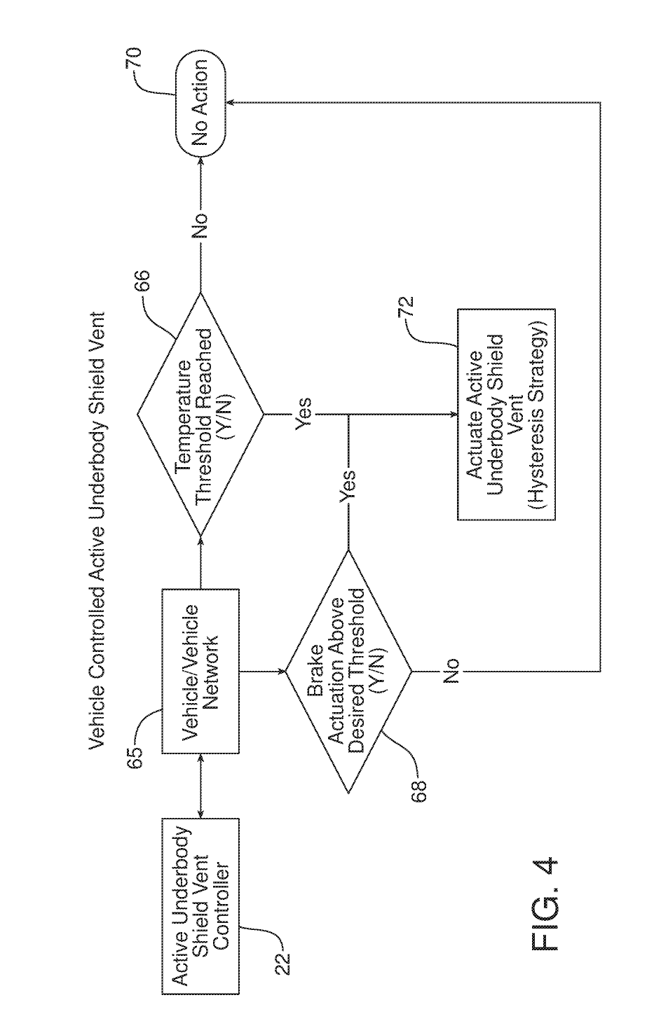

As should be appreciated, the active aerodynamic underbody shield system 10 may incorporate any one or more of these monitoring devices 58, 60, 62, 64 capable of monitoring the braking and attitude of the motor vehicle. Still further, one or more of the monitoring devices 58, 60, 62, 64 may comprise an additional monitoring device selected from a second group consisting of an engine coolant temperature monitor, an engine cylinder temperature monitor and combinations thereof capable of monitoring engine operating temperatures. As should be appreciated, any one or more of the monitoring devices 58, 60, 62, 64 may be connected to the respective data inputs 50, 52, 54, 56 via the controller area network (CAN) of the motor vehicle (shown at 65 in FIG. 4).

Reference is now made to FIG. 4 illustrating one possible embodiment of control logic flow diagram for the controller 22. In this embodiment, the controller 22 monitors motor vehicle motor operating temperature and brake actuation at respective boxes 66 and 68. If the indicated motor temperature is below the threshold, no action is taken at box 66. In contrast, if the motor vehicle motor temperature is above the predetermined threshold, the controller 22 provides a control signal to the actuator 18 causing the actuator 18 to displace the panel 16 into the vent opening position illustrated in FIG. 3.

If the brake actuation is determined by the monitoring device 58 to be below the predetermined threshold, no action is taken at box 70. In contrast, if brake actuation is determined to be above the predetermined desired threshold, (box 72), the controller 22 sends an appropriate control signal to the actuator 18 causing the actuator to displace the panel 16 into the vent opening position of FIG. 3. Thus, it should be appreciated that the panel 16 is maintained in the vent opening position whenever the motor vehicle temperature is above the predetermined threshold or brake actuation is above the predetermined desired threshold. At all other times, the controller 22 is configured to send an appropriate signal to the actuator 18 to displace and maintain the panel 16 in the vent closing position illustrated in FIGS. 2a and 2b.

As should be appreciated, the control logic flow diagram of FIG. 4 should be considered as illustrative in nature and not as restrictive. A multitude of alternative control logic flow diagrams may be provided for the controller 22 to use data provided by one or more of the monitoring devices 58-64 which, as noted above, may be selected from a group consisting of a brake pedal actuation switch, a brake pressure monitor, a vehicle speed monitor, a lateral acceleration monitor, a longitudinal acceleration monitor, a ride height monitor, a front wheel position monitor, a steering wheel angle monitor, an engine coolant temperature monitor and an engine cylinder temperature monitor.

Consistent with the above description, a method is provided of reducing downforce and providing better lift balance adjustment during vehicle braking. That method may be broadly described as comprising the steps of detecting vehicle braking by means of a monitoring device (note one or more of the monitoring devices 58, 60, 62, 64), opening the vent 14 in the underbody shield 12 by the actuator 18 and controlling the actuator by the controller 22 configured to open the vent during vehicle braking.

The method may include monitoring brake pedal activation, brake pressure, motor vehicle speed, motor vehicle lateral acceleration, motor vehicle longitudinal acceleration, motor vehicle ride height, front wheel position, steering wheel angle, operating temperature and any combination thereof. Motor operating temperature may be monitored by means of, for example, a motor coolant temperature monitor or a motor cylinder temperature monitor.

The foregoing has been presented for purposes of illustration and description. It is not intended to be exhaustive or to limit the embodiments to the precise form disclosed. Obvious modifications and variations are possible in light of the above teachings. For example, the illustrated embodiment includes four monitoring devices 58, 60, 62, 64. It should be appreciated that as few as one and as many as ten or more may be used to provide data to the controller 22 depending upon the control logic of the controller. All such modifications and variations are within the scope of the appended claims when interpreted in accordance with the breadth to which they are fairly, legally and equitably entitled.

What is claimed:

1. An active aerodynamic underbody shield system, comprising:
an underbody shield including a vent;
a panel displaceable between a vent closing position and a vent opening position;
an actuator to displace said panel; and
a controller for said actuator, said controller configured to open said vent during vehicle braking to reduce downforce and thereby provide lift balance adjustment.

2. The active aerodynamic underbody shield system of claim 1, further including a panel support having a guideway.

3. The active aerodynamic underbody shield system of claim 2, wherein said guideway includes opposed guide channels and said panel slides in said opposed guide channels.

4. The active aerodynamic underbody shield system of claim 3, wherein said actuator is connected to said panel by a linkage.

5. The active aerodynamic underbody shield system of claim 4, further including a mesh cover across said vent.

6. The active aerodynamic underbody shield system of claim 5, wherein said controller is configured to include at least one data input.

7. The active aerodynamic underbody shield system of claim 6, further including at least one monitoring device connected to said at least one data input, said at least one monitoring device being selected from a first group consisting of a brake pedal actuation switch, a brake pressure monitor, a vehicle speed monitor, a lateral acceleration monitor, a longitudinal acceleration monitor, a ride height monitor, a front wheel position monitor, a steering wheel angle monitor and combinations thereof.

8. The active aerodynamic underbody shield system of claim 7, further including an additional monitoring device connected to an additional data input, said additional monitoring device being selected from a second group consisting of an engine coolant temperature monitor, an engine cylinder temperature monitor and combinations thereof.

9. The active aerodynamic underbody shield system of claim 7, wherein said actuator is selected from a third group consisting of an engine vacuum actuator, an electrical actuator, a solenoid, a pneumatic actuator and a hydraulic actuator.

10. The active aerodynamic underbody shield system of claim 9, wherein said linkage includes a first link and a second link, said first link connected by a pivot pin to said underbody shield, said first link having a first end connected to said actuator and a second end connected to second link, said second link being connected to said panel.

11. A method of reducing downforce and providing lift balance adjustment during vehicle braking, comprising:
detecting, by a monitoring device, vehicle braking;
opening, by an actuator, a vent in an underbody shield; and
controlling said actuator by a controller configured to open said vent during said vehicle braking.

12. The method of claim 11, including monitoring brake pedal activation with said monitoring device.

13. The method of claim 11, including monitoring brake pressure with said monitoring device.

14. The method of claim 11, including monitoring vehicle speed with said monitoring device.

15. The method of claim 11, including monitoring vehicle lateral acceleration with said monitoring device.

16. The method of claim 11, including monitoring vehicle longitudinal acceleration with said monitoring device.

17. The method of claim 11, including monitoring vehicle ride height with said monitoring device.

18. The method of claim 11, including monitoring front wheel position with the monitoring device.

19. The method of claim 11, including monitoring steering wheel angle with the monitoring device.

20. The method of claim 11, including monitoring motor operating temperature.
